(19) United States
(12) Patent Application Publication
(10) Pub. No.: US 2016/0330950 A1
(43) Pub. Date: Nov. 17, 2016

(54) Ground Rodent Prevention Assembly

(71) Applicant: Jim Preston, New Carlisle, OH (US)

(72) Inventor: Jim Preston, New Carlisle, OH (US)

(21) Appl. No.: 14/712,029

(22) Filed: May 14, 2015

(51) Int. Cl. A01M 29/30; A01M 17/00

(52) U.S. Cl. CPC A01M 29/30; A01M 17/00

(57) ABSTRACT

A ground rodent prevention assembly includes a pair of outer walls each has an inner surface and an outer surface. The outer walls are laterally spaced from each other and oriented parallel to each other. The inner surfaces of the outer walls face each other. A front axle extends between the outer walls and is positioned adjacent to a front end of each of the outer walls. A cylinder is mounted on the front axle and is rotatable with respect to the outer walls. A plurality of spikes is attached to and extends outwardly from the cylinder. The spikes radially extend away from the cylinder. A handle is attached to the outer walls.

### BACKGROUND OF THE DISCLOSURE

### Field of the Disclosure

The disclosure relates to rodent tunnel perforating devices and more particularly pertains to a new rodent tunnel perforating device for puncturing and collapsing tunnels made in a lawn or under other ground surfaces.

### SUMMARY OF THE DISCLOSURE

An embodiment of the disclosure meets the needs presented above by generally comprising a pair of outer walls each has an inner surface and an outer surface. The outer walls are laterally spaced from each other and oriented parallel to each other. The inner surfaces of the outer walls face each other. A front axle extends between the outer walls and is positioned adjacent to a front end of each of the outer walls. A cylinder is mounted on the front axle and is rotatable with respect to the outer walls. The cylinder has a length extending between the outer walls between 10.0 inches and 18.0 inches. The cylinder has a diameter between 4.0 inches and 7.0 inches. A plurality of spikes is attached to and extends outwardly from the cylinder. The spikes radially extend away from the cylinder and extend outwardly from the cylinder a distance between 3.0 inches and 5.0 inches. A handle is attached to the outer walls.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a ground rodent prevention assembly according to an embodiment of the disclosure.

FIG. 2 is a front view of an embodiment of the disclosure.

FIG. 3 is a side view of an embodiment of the disclosure.

FIG. 4 is a cross-sectional view of an embodiment of the disclosure taken along line 4-4 of FIG. 2.

### DESCRIPTION OF THE PREFERRED EMBODIMENT

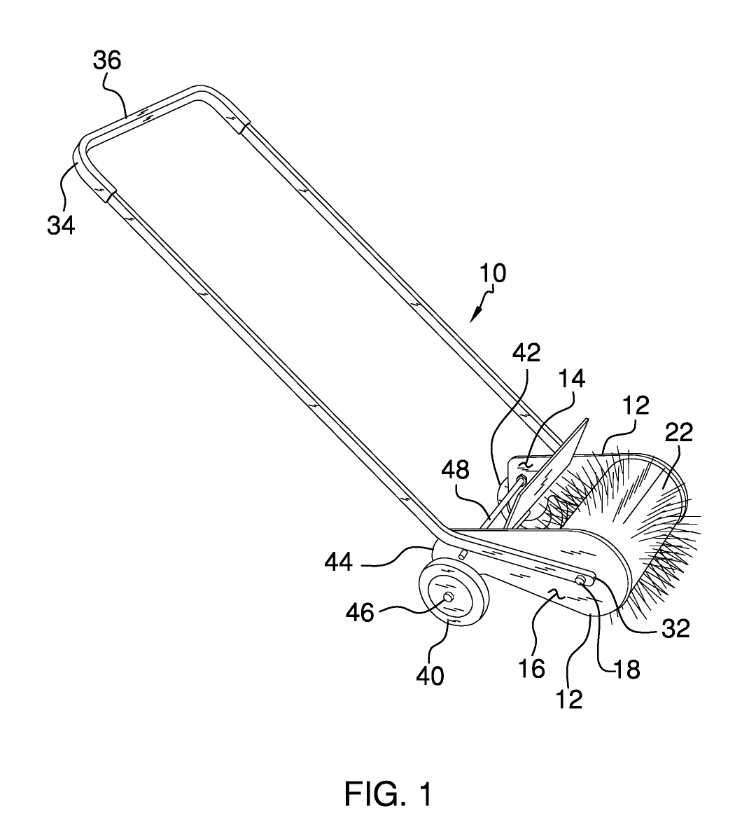

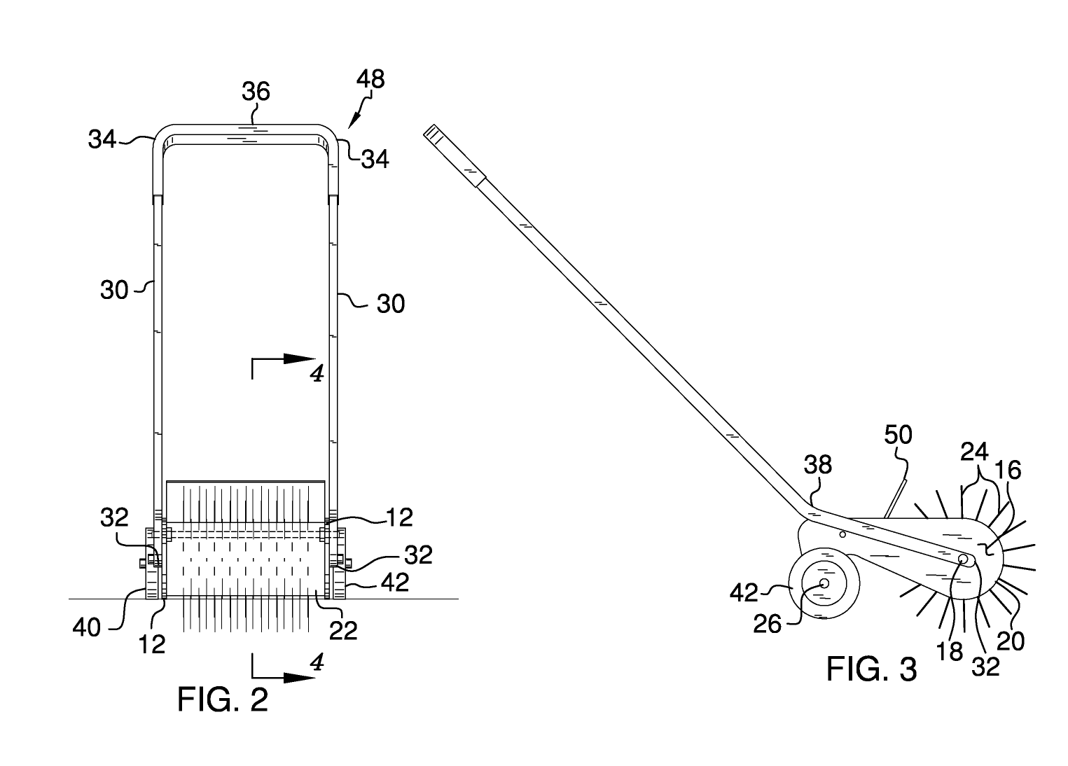

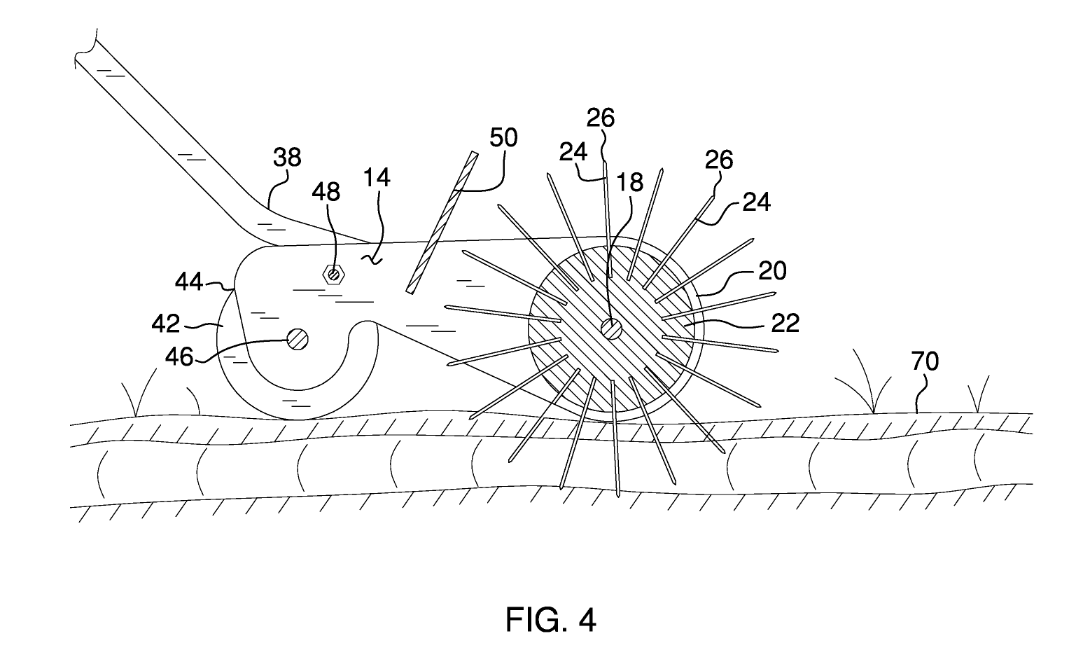

With reference now to the drawings, and in particular to FIGS. 1 through 4 thereof, a new rodent tunnel perforating device embodying the principles and concepts of an embodiment of the disclosure and generally designated by the reference numeral 10 will be described.

As best illustrated in FIGS. 1 through 4, the ground rodent prevention assembly 10 generally comprises a pair of outer walls 12 each having an inner surface 14 and an outer surface 16. The outer walls 12 are laterally spaced from each other and oriented parallel to each other. The inner surfaces 14 of the outer walls 12 face each other. A front axle 18 extends between the outer walls 12 and is positioned adjacent to a front end 20 of each of the outer walls 12. A cylinder 22 is mounted on the front axle 18 and is rotatable with respect to the outer walls 12. The cylinder 22 has a length extending between the outer walls 12 between 10.0 inches and 18.0 inches and the cylinder 22 has a diameter between 4.0 inches and 7.0 inches. The cylinder 22 may be weighted by either providing a solid mass of material from which the cylinder 22 is formed or by filling the cylinder 22 with a weighting material such as sand, water or the like. The cylinder 22 will typically have a weight greater than at least 5.0 lbs and may have a weight greater than 10.0 lbs.

A plurality of spikes 24 is attached to and extends outwardly from the cylinder 22. The spikes 24 radially extend away from the cylinder 22 and extend outwardly from the cylinder 24 a distance between 3.0 inches and 5.0 inches. The spikes 24 each have a pointed end 26 and may be comprised of a metallic material which is generally not easily bent. Such metallic materials may include for instance iron, aluminum, titanium, their alloys and the like. The spikes 24 are spread out such that there pointed ends 26 are generally between 0.5 inches and 2.0 inches away from each other while being aligned with each other along rows extending between the outer walls 12.

A handle 28 is provided which includes a pair of arms 30. Each of the arms 30 has a first end 32 and a second end 34. Each of the outer walls 12 has one of the arms 30 pivotally coupled thereto adjacent to an associated one of the first ends 32. The arms 30 may be pivotally coupled to the front axle 18. A grip 36 joins the second ends 34 together and the first ends 32 are positioned adjacent to the front ends 20 of the outer walls 12. As can be seen, the arms 30 may each include a bend 38 therein positioned nearer to the first ends 32 than the second ends 34. The bends 38 each form an angle of between 110° and 170° in the arms 30.

A first wheel 40 and a second wheel 42 are provided and each of the outer walls 12 has one of the first 40 or second 42 wheels rotatably coupled thereto. The first 40 and second 42 wheels are positioned adjacent to a back end 44 of an associated one of the outer walls 12. The first 42 and second 44 wheels may be rotatably positioned on a rear axle 46 extending through the outer walls 12.

A stop 48 is attached to the outer walls 12. The stop 48 is positioned between the front axle 18 and the back ends 44 of the outer walls 12. The stop 48 engages the handle 28 when the grip 36 is moved vertically downward to lift the front axle 18 with respect to the rear axle 46 such that the cylinder 22 is lifted vertically away from a ground surface 70 when the grip 36 is moved vertically downward. More specifically, the portion of the arms 30 between the first ends 32 and the bends 38 engages the stop 48 when the handle 28 is pushed downwardly to cause the first ends 18 to lift upwardly and the entire assembly 10 to ride on the first 40 and second 42 wheels. This lifts the spikes 24 off of the ground surface 70.

A guard wall 50 is attached to and extends between the outer walls 12 and is oriented such that the guard wall 50 is angled toward the cylinder 22. The guard wall 50 extends upwardly to a height greater than the spikes 24 during usage of the assembly 10 to prevent material from the spikes 24 from being thrown rearwardly toward the user of the assembly 10.

In use, the assembly 10 is used to bore holes through the ground surface 70 and into tunnels 72, made by rodents such as moles, to cause the tunnels 72 to collapse as well as possibly kill the rodents should they be in the tunnels 72. The user simply moves cylinder 22 across the ground surface 70 and lifts the spikes 24 upwardly with the handle 28 and the stop 48 when all areas needed have been punctured.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A mole prevention assembly comprising:
a pair of outer walls each having an inner surface and an outer surface, said outer walls being laterally spaced from each other and oriented parallel to each other, said inner surfaces of said outer walls facing each other;
a front axle extending between said outer walls and being positioned adjacent to a front end of each of said outer walls;
a cylinder being mounted on said front axle and being rotatable with respect to said outer walls, said cylinder having a length extending between said outer walls between 10.0 inches and 18.0 inches, said cylinder having a diameter between 4.0 inches and 7.0 inches; and
a plurality of spikes being attached to and extending outwardly from said cylinder such that said spikes are spaced apart from each other, each said spike having an elongated cylindrical shape with a pointed end, said spikes radially extending away from said cylinder and extending outwardly from said cylinder a distance between 3.0 inches and 5.0 inches; and
a handle being attached to said outer walls.

2. The mole prevention assembly according to claim 1, wherein said handle includes a pair of arms, each of said arms having a first end and a second end, each of said outer walls having one of said arms pivotally coupled thereto adjacent to an associated one of said first ends, a grip joining said second ends together.

3. The mole prevention assembly according to claim 1, further including:
said first ends being positioned adjacent to said front ends of said outer walls;
a first wheel and a second wheel, each of said outer walls having one of said first or second wheels rotatably coupled thereto, said first and second wheels being positioned adjacent to a back end of an associated one of said outer walls; and
a stop being attached to said outer walls, said stop being positioned between said front axle and said back ends of said outer walls, said stop engaging said handle when said grip is moved vertically downward to lift said front axle with respect to said rear axle, wherein said cylinder is lifted vertically away from a ground surface when said grip is moved vertically downward.

4. The mole prevention assembly according to claim 1, further including a first wheel and a second wheel, each of said outer walls having one of said first or second wheels rotatably coupled thereto, said first and second wheels being positioned adjacent to a back end of an associated one of said outer walls.

5. A mole prevention assembly comprising:
a pair of outer walls each having an inner surface and an outer surface, said outer walls being laterally spaced from each other and oriented parallel to each other, said inner surfaces of said outer walls facing each other;
a front axle extending between said outer walls and being positioned adjacent to a front end of each of said outer walls;
a cylinder being mounted on said front axle and being rotatable with respect to said outer walls, said cylinder having a length extending between said outer walls between 10.0 inches and 18.0 inches, said cylinder having a diameter between 4.0 inches and 7.0 inches;
a plurality of spikes being attached to and extending outwardly from said cylinder such that said spikes are spaced apart from each other, each said spike having an elongated cylindrical shape with a pointed end, said spikes radially extending away from said cylinder and extending outwardly from said cylinder a distance between 3.0 inches and 5.0 inches;
a handle including a pair of arms, each of said arms having a first end and a second end, each of said outer walls having one of said arms pivotally coupled thereto adjacent to an associated one of said first ends, a grip joining said second ends together, said first ends being positioned adjacent to said front ends of said outer walls;
a first wheel and a second wheel, each of said outer walls having one of said first or second wheels rotatably coupled thereto, said first and second wheels being positioned adjacent to a back end of an associated one of said outer walls, said first and second wheels being rotatably positioned on a rear axle extending through said outer walls; and
a stop being attached to said outer walls, said stop being positioned between said front axle and said back ends of said outer walls, said stop engaging said handle when said grip is moved vertically downward to lift said front axle with respect to said rear axle, wherein said cylinder is lifted vertically away from a ground surface when said grip is moved vertically downward.
